(19) United States
(12) Patent Application Publication
(10) Pub. No.: US 2010/0121740 A1
(43) Pub. Date: May 13, 2010

(54) DATA DRIVEN ORCHESTRATION OF BUSINESS PROCESSES

(75) Inventors: Lynn Leah Reed, Newburyport, MA (US); Muhammd Zeeshan Butt, Foster City, CA (US); Shrikant Nene, Fairfield, CT (US); Alok Singh, Fremont, CA (US); Krishna Raju Venkata Addala, Westford, MA (US)

Correspondence Address: Trellis IP Law Group/Oracle, 1900 Embarcadero Road, Suite 109, Palo Alto, CA, 94303, US

(73) Assignee: Oracle International Corporation, Redwood Shores, CA (US)

(21) Appl. No.: 12/617,695

(22) Filed: Nov. 12, 2009

Related U.S. Application Data
(60) Provisional application No. 61/114,266, filed on Nov. 13, 2008.

(51) Int. Cl. G06F 9/46; G06F 3/048; G06F 15/16

(52) U.S. Cl. 705/27; 718/102; 715/810; 709/206

(57) ABSTRACT

In one embodiment, abstraction of business processes from an underlying information technology (IT) infrastructure is provided. An orchestration process can be designed using encapsulated service invocations. A plurality of services may be provided that are configured to provide services in the order fulfillment business process. An interface may be used by a user to provide a definition of a business process. The business process may identify one or more services that define steps to be performed in the order fulfillment process. This definition may include metadata that can be stored in a runtime table. During runtime, the metadata may be read from the table and used by the run-time engine to perform an executable process. The one or more services may be dynamically invoked during orchestration of the executable process, which coordinates performance of the services.

### CROSS REFERENCES TO RELATED APPLICATIONS

This invention claims priority from U.S. Provisional Patent application Ser. No. 61/114,266 filed on Nov. 13, 2008 which is hereby incorporated by reference as if set forth in full in this application.

### BACKGROUND

Particular embodiments generally relate to the orchestration of business processes.

Business processes are typically modeled by business architects/analysts. A business process may model message exchanges with different systems in a web services environment. The business architects/analysts then provide an information technology (IT) designer with the model. The IT designer uses an orchestration language, such as business process execution language (BPEL), to code the business process. Currently, it is only possible to create BPEL processes in a BPEL editor and invoke a deployed BPEL process. Because the IT designer and business architects/analysts have different skill sets (the business architects/analysts are familiar with the business process being modeled and the IT designer is familiar with the orchestration language but not the business process), the resulting BPEL process developed by the IT designer may not work as the business architects/analysts imagined. Accordingly, there may be a wide divide between the originally conceived business process model and the implemented model.

### SUMMARY

Particular embodiments provide a method for orchestrating an order fulfillment business process. In one embodiment, abstraction of business processes from an underlying information technology (IT) infrastructure is provided. An orchestration process can be designed using encapsulated service invocations. A plurality of services may be provided that are configured to provide services in the order fulfillment business process. An interface may be used by a user to provide a definition of a business process. The business process may identify one or more services that define steps to be performed in the order fulfillment process. This definition may include metadata that can be stored in a runtime table. During runtime, the metadata may be read from the table and used by the run-time engine to perform an executable process. The one or more services may be dynamically invoked during orchestration of the executable process, which coordinates performance of the services.

Accordingly, the business process can be modeled using the interface. The interface may be a web-based administration user interface in which the business processes are modeled using the services provided. Changes may be made to the business process and are able to influence the sequence of steps performed in the executable process dynamically at runtime. By using the interface to define the business process, the business process does not need to be handed off to an IT designer for programming of the executable process. Rather, the services are automatically invoked to perform the executable process upon receiving the definition from the interface.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a system for providing an orchestration process design and authoring environment according to one embodiment.

FIG. 2 depicts an example of an interface according to one embodiment.

FIG. 3 describes the runtime operation according to one embodiment.

FIG. 4 depicts an example of invocation of services using a flow sequencer according to one embodiment.

FIG. 5 depicts a process for orchestration data flow among different layers according to one embodiment.

FIG. 6 depicts a simplified flowchart of a method for changing an executable process according to one embodiment.

### DETAILED DESCRIPTION OF EMBODIMENTS

Particular embodiments provide a tool that provides a high degree of abstraction for business process modeling in an order fulfillment business process. Business processes may be modeled by users, such as business analysts, and do not need any coding from an IT designer to have the business process executed. Users are provided the flexibility to define business processes in a user interface, such as a web-based administration user interface. The business process may identify one or more services that define steps to be performed in the order fulfillment process. A run-time engine then uses the definition to dynamically invoke the services based on the definition of the business process.

In the business environment, business users are often process modelers, not IT personnel. By providing a web-based administration environment, the business users may be able to design the business process. The process definitions may be defined in business terms and not in IT terms. Particular embodiments allow an administrative environment outside of a code editor, such as a BPEL editor, for defining processes using associated services. Users can configure processes that can be executed at runtime as executable processes without IT involvement. This alleviates the need for deploying the processes every time a modification of the business process is needed. The user sets up the sequence of services on a data table. The modeled business process is then used to perform an executable process, which is assembled and executed at run-time. In one embodiment, ‘run-time’ can be defined as the time when an order is received for processing. Metadata is assembled in data run-time table and used to define the executable process for the business process. The metadata is used to invoke services in the executable process.

In one example, the services invoked are encapsulated and reusable. The metadata is used to determine how and when to invoke services. Also, depending on the metadata, input arguments are generated and sent to the services to invoke the encapsulated service. A common signature is used to send data to invoke the services. Different input arguments can be formulated for different services used in different executable processes. The input arguments are formatted in the same way such that a service can read the different sets of data and invoke the service. Thus, services can be re-used in different business processes without the need to be re-coded and redeployed. Deployment of services indicates the process is ready to be released for testing or production.

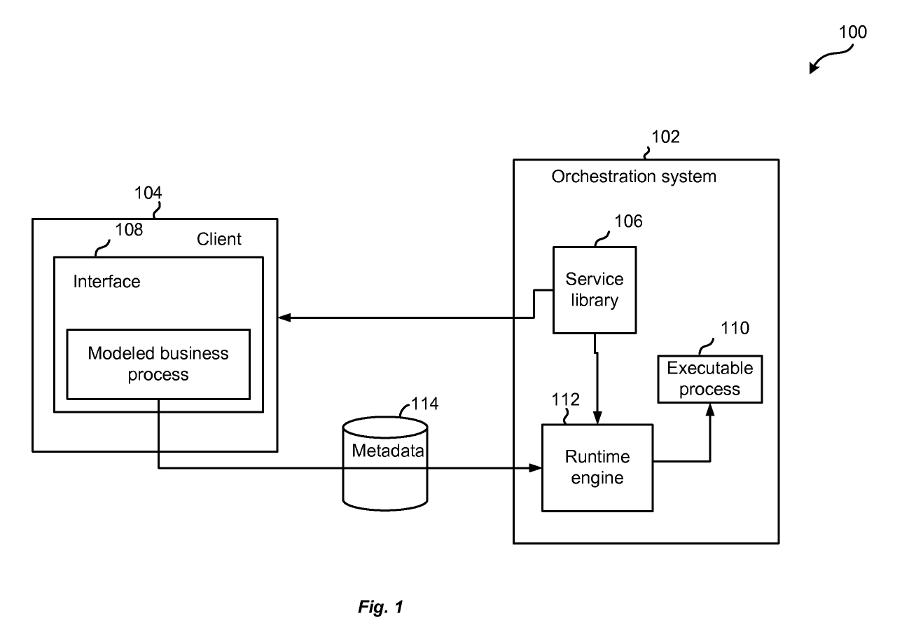

FIG. 1 depicts an example of a system 100 for providing an orchestration process design and authoring environment according to one embodiment. System 100 includes an orchestration system 102 and a client 104. Although single instances of orchestration system 102 and client 104 are provided, it will be understood that multiple instances may be used. Also, orchestration system 102 and client 104 may be part of a distributed computing system. That is, functions described may be. distributed among various computing devices.

Client 104 may be a computing device or set of computing devices that are configured to allow a business process to be modeled. Orchestration system 102 orchestrates the invocation and running of services for an executable process 110 for the business process. Orchestration, as described, may be the coordination and invoking of services that need to be performed in the business process.

As used, a business process may be modeled by a user. The business process is a definition of steps to be performed. The steps are defined in interface 108. An executable process is the process that is executed by run-time engine 112. The executable process includes code that is executed to coordinate performing of services.

A service library 106 that includes multiple services that can be included in a business process. In one embodiment, a service library 106 includes services that can be performed in an order fulfillment business process. Order fulfillment involves processes that are performed to fulfill an order. For example, an order may be received from an order capture system. The order may be for a good, service, etc. Different services may be performed to fulfill the order, such as shipment, installation, invoicing, etc. The order fulfillment process may be characterized in these different services. It is expected for any given order, some or all of these processes may need to be performed to fulfill the order. Accordingly, particular embodiments create services for the services that are expected to be performed in an order fulfillment process.

Services can be non-configurable units and configurable units. Non-configurable units are services that are built and provided to customers. The non-configurable units are units that likely may be used in an order fulfillment process. For example, it is expected that different services may have to be performed in the order fulfillment process, such as account receivable. Accordingly, these services may be modeled using a language, such as BPEL. Although BPEL is described, it will be understand that other languages may be used.

Configurable units are services that are built and defined by a customer. For example, a wrapper is provided around a service that is configured by a user. For example, a customer may want a shipping service that is specific to the customer's company. Accordingly, the service performed by the configurable unit may be defined and built by a customer, but the wrapper allows runtime engine 112 to invoke the service automatically. This allows customers to define services that are needed for their individual organizations.

The services may be re-used in different business processes. The services are encapsulated and configured to receive a common signature for the service to be performed. For example, for each business process, different parameters may be provided (i.e., different products may be ordered for different prices, etc.). This causes different input arguments to be inputted into the service. The common signature defines a data structure that allows the service to be re-used for different executable processes 110. Thus, the same deployed service is used to process different input arguments for the different orders, but different results may be obtained. In this way, the order fulfillment process can be abstracted. Different users can define which services need to be performed without regard to how the processes are coded in an orchestration language.

Interface 108 may be an administration user interface. For example, a graphical user interface allows a user to model a business process at an abstract level. For example, service library 106 may be provided to client 104. The user may then use interface 108 to define steps of the business process using services in service library 106. A user may define a plurality of steps in the business process. Each step may be associated with a service in service library 106.

The steps may be stored in a data table, which may include metadata that may be used by runtime engine 112 to orchestrate executable process 110. The data table is shown as being stored in storage 114. It will be understood that the data table may be stored in any area, such as in client 104, orchestration system 102, or any other device. The metadata may be defined by the user, determined from data tables, and/or orchestration rules. The user defines the sequence in which the services are to be invoked as well as conditional or parallel branching that may be required to effect the business processing rules. When the user selects a service for a process step, the user also provides additional metadata that is used to determine how the processing data is to be executed during the processing of an order at runtime. For example, conditional or parallel branching is defined.

At runtime, runtime engine 112 receives the metadata and uses it to determine parameters for the orchestration of executable process 110. Runtime engine 112 uses the parameters to determine which steps to perform and when in executable process 110. For example, runtime engine 112 orchestrates executable process 110 by invoking services in the series of steps that have been defined by the user. As will be described in more detail below, parallel and conditional processing of steps can also be performed. Also, the metadata can be used to determine the input arguments used to invoke the services.

The metadata for the table is read at runtime and services are invoked, which allows changes to executable process 110 to be performed and realized at runtime automatically. Runtime engine 112 reads through each step that is defined and performs the steps. If a change in service is desired, the user may use interface 108 to add/delete/replace a service. At run-time, when the table is read, the change may be automatically performed.

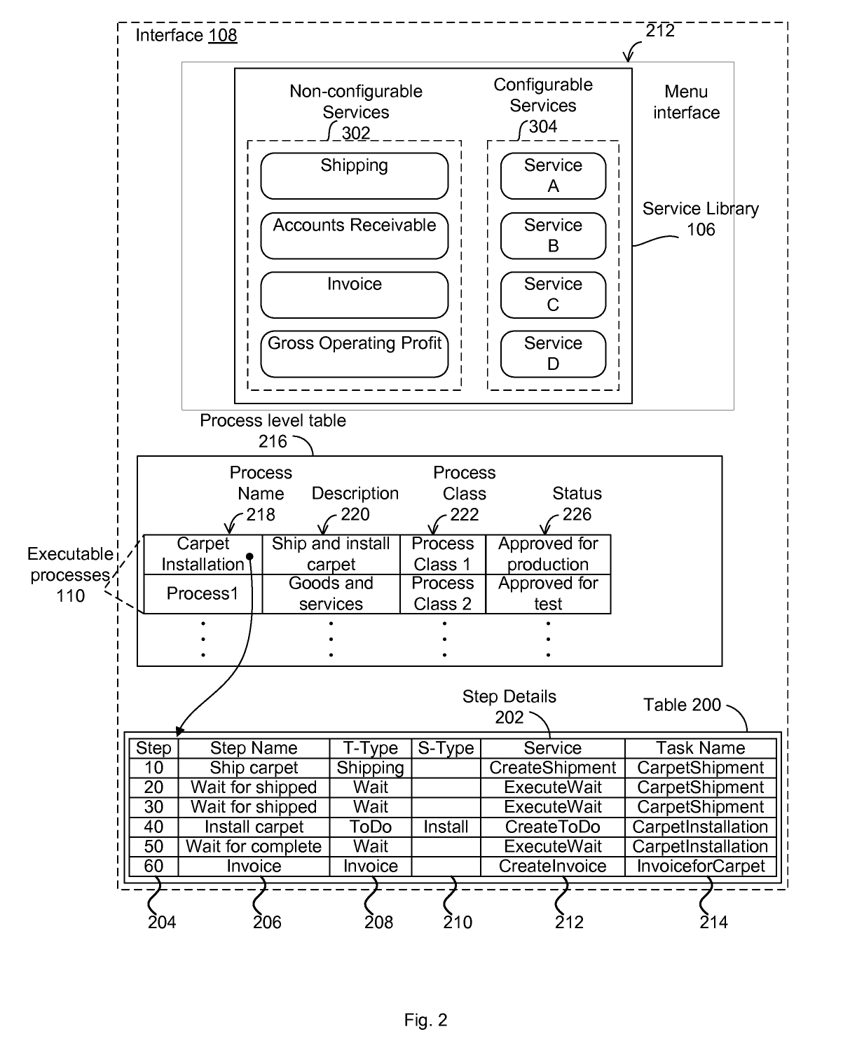

FIG. 2 depicts an example of an interface 108 according to one embodiment. Process level table 216 summarizes different business processes that have been modeled. As shown, the business processes—Carpet Installation and Process 1—have been modeled by a user.

In process level table 216, a process name column 218 shows a carpet installation business process and process 1 have been modeled. A description column 220 describes the process. A process class column 222 describes the class of the process. A status column 226 is the status of the executable process. There may be different statuses of executable processes 110. For example, some business processes may be approved for production, approved for test, or may be new. Production means that the service is approved for regular business use, approved for test is approved for testing, and new is a service in development.

A business process in table 216 can be selected and data table 200 may show the step details for individual business processes. One business process is entitled Carpet Installation and a data table 200 of step details shows each service that has been defined for the Carpet Installation.

In data table 200, a step column 204 identifies the steps in the business process. For example, steps 10-60 are provided. Services for these steps may be performed at runtime. The steps may be run in sequence from top to bottom (or in any other order). In this case, a step 10 is performed and when finished, a step 20 is performed, and so on. Additionally, although not shown, conditional and parallel steps may also be defined using interface 108. Conditional steps are steps that depend on a result occurring (e.g., another step finishing) and parallel steps are performed in parallel. A user defines whether steps should be conditional or parallel.

Step name column 206 provides a descriptive name for the steps. For example, ship carpet, wait for shipped, install carpet, wait for complete, and invoice steps are provided.

A task type column 208 describes what type of task is being performed. For example, for the ship carpet task, an external system may perform a shipping task and for the invoice step, an invoice system may invoice for a bill.

A service column 212 identifies the service associated with the step. A task name column 214 is the name of the task. For example, theses tasks have to do with carpet and are named carpet shipment, carpet installation, and invoice for carpet. It is possible that if something other than a carpet is being installed, the task name may be different. For example, a sink shipment, sink installation, and invoice for sink may be the names of these tasks.

Users may use interface 108 to generate data table 200. A user may select services from a menu for service library 106. For example, a user uses a menu interface 212 to select services from service library 106. Drop-down menus, drag-and-drop options, and other visual processes may be used to define executable process 110. Users are provided with an orchestration-specific interface that presents the business process data with suitable validations, rather than being required to learn the complexities of a multipurpose IT development environment. This allows a user to model a business process in an abstract manner, but have executable process 110 be generated and executed from the model.

The services in service library 106 may be made up of non-configurable units and configurable units. For example, non-configurable units are provided in a column 302 and configurable units are provided in a column 304. As shown, services that are non-configurable include shipping, accounts receivable (AR), invoice, and global order promising (GOP). Also, configurable units are designated as A, B, C, and D.

Table 200 is generated as shown in interface 108 using menu 212. Table 200 is associated with metadata that describes the services to be performed and any arguments that are needed to invoke the services.

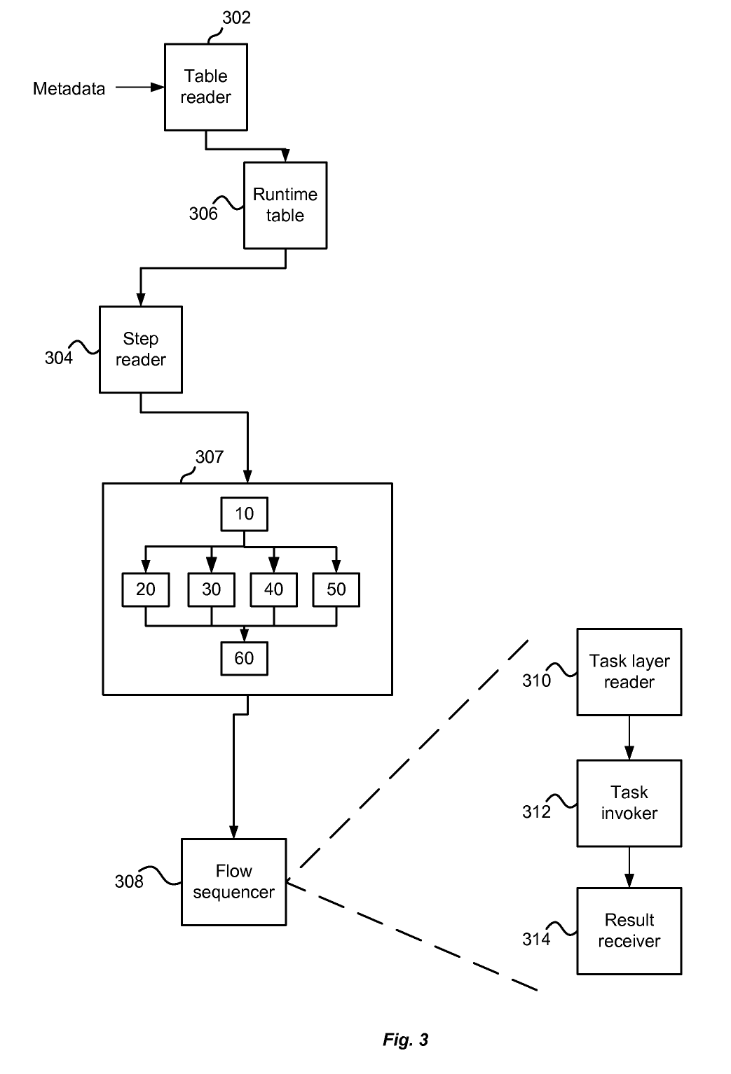

Once the business process is modeled in interface 108 and released by setting the process status, runtime engine 112 is used to orchestrate the invocation of the services. FIG. 3 describes the runtime operation according to one embodiment. A table reader 302 receives metadata from interface 108 defining the business process. Table reader 302 may copy the data to a runtime table 306 but this is not necessary.

During run-time, a step reader 304 is configured to read the steps in runtime table 306. Step reader 304 may analyze the metadata and determine which steps should be executed and when. For example, step reader 304 checks to see if parallel or conditional branching is associated with a step. The metadata is also used to determine input arguments for the services. The input arguments may be determined from the metadata, from data in lookup tables, or determined using rules.

Step reader 304 may assemble executable process 110 using encapsulated services from service 106 and the metadata. For example, code for each service that was modeled in the steps is determined for executable process 110. The input arguments for each service are also determined. For example, the metadata is used to determine the input arguments such that the services can process an order for the business process. Also, any partner links are determined using the metadata to allow the services to interact with external systems. Executable process 110 is assembled based on the definition of steps in the business process. Because services are re-usable, the same code for a service can be used for different business processes. However, the input arguments or partner links may be different. Because the same code is re-used, automatic assembly of executable process 110 is provided.

A flow sequencer 308 is used to dynamically invoke the steps at the appropriate time based on executable process 110. As shown, a step 10 may determine a service to invoke. One of steps 20, 30, 40, and 50 are then performed. Step 60 then determines if other steps need to be performed. In this case, one of the other steps in 20, 30, 40, and 50 could be performed. Flow sequencer 308 may determine relevant input arguments depending on the content of the metadata received. These input arguments are then used to invoke a service. For example, flow sequencer 308 may include a task layer reader 310 that determines a service to invoke. A task invoker 312 then dynamically invokes the service. Any input arguments are used to invoke the service. In invoking the service, code for the encapsulated service is executed to coordinate performing of the service. For example, the executed code may prepare and send a message to an external system to perform the service.

The service may then be performed and the result is received at result receiver 314. In one example, if the task is shipping, then a shipping service generates a message for a shipping system regarding the shipping of a good. Once the shipping system ships the good, a message is returned to the shipping service, which stores the result.

After receiving a result, it is then checked whether further sequences need to be performed. For example, a while activity module checks to see whether further services need to be processed. For example, the process may be returned to flow sequencer 308 to allow for dynamic invocation of other steps in the process. Also, the while activity module may wait until parallel branches are completed.

Accordingly, the information required to invoke the services is determined automatically based on the runtime table. In one example, in BPEL, necessary partner links for all invocations have been created and are used to invoke the services. The services represented in the BPEL partner links are deployed BPEL processes that require no further configuration in order to be used in multiple business process definitions. When a service is invoked by the runtime engine, the corresponding partner link is accessed in the underlying BPEL process. Assembly of a service and modification of any service take place through the use of the metadata found in the runtime table and may be managed through interface 108.

Accordingly, a user can set up the steps in a business process. Executable process 110 can be automatically assembled at run-time. The code used in executable process 110 is not generated by the user who set up the business process. Rather, metadata can be defined and is used to assemble encapsulated services for executable process 110.

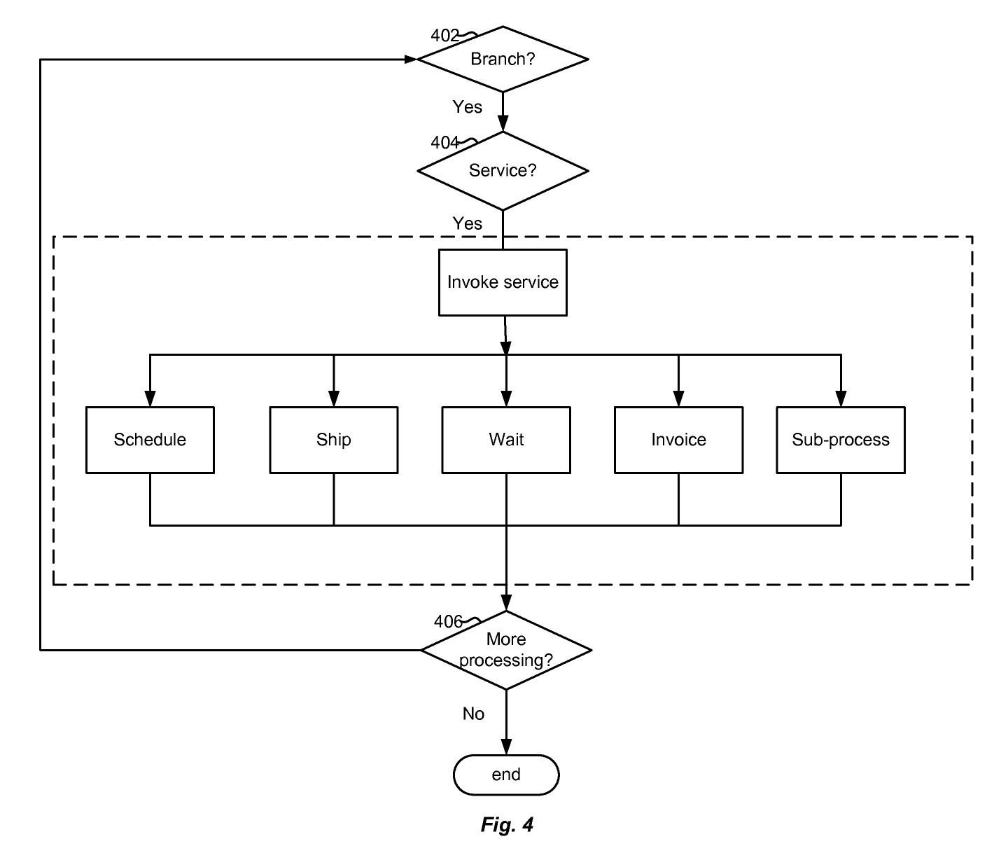

FIG. 4 depicts an example of invocation of services using flow sequencer 308 according to one embodiment. At step 402, it is determined if branching is needed. If a conditional statement is encountered, the process proceeds down the appropriate branch based on which condition is satisfied. If parallel branching is encountered, parallel flow sequence instances are spawned to carry out the additional branches. The branching is determined and used later in invoking services. The process then proceeds to step 404 in which a service is determined.

Various services may then be performed. The steps include an invoke service step, schedule step, ship step, wait step, invoice step, and sub-process step. Identical processing sequences can flow in parallel until a unifying step is reached. Each flow sequence contains the same underlying coded process (such as a BPEL process), but different processing sequences can be used in different executable processes 110. That is, one sequence may contain Schedule, Ship, Invoice while another may contain Schedule, Activity, Ship, Activity, Invoice, although the runtime engine including the underlying coded processes do not change. That is, the code for each service that is invoked stays the same even though different executable processes are being run.

An external service invocation is contained in each branch of the flow sequencer, one branch for each service that can be invoked. The branch contains all the steps necessary to set up the data that should be included in the message to the specific external service and to format the response received from the service. Once a service is complete, the while activity module checks to see if there are further services to process and either returns to flow sequencer 408, continues to the next step in the process or waits until any parallel branches are complete.

Box 406 shows a conceptual execution of executable process 110. Not all steps may be run at once. For example, the invoke service is invoked for step 10 and determines a service to invoke. Once that is completed, step 408 determines if other steps need to be performed. In this case, step 404 determines the Schedule, Ship, Wait, Invoice, and subprocesses services should be performed. Once all the flows have been completed, a uniform set of results can be constructed. Based on the definition of the executable process, it is determined if additional processing should be performed. Different branches are performed where each branch invokes the associated service. Input arguments for the service are generated from the metadata in the runtime table. When the selected service has been performed, step 406 determines if additional services should be performed. If so, the process reiterates to step 402. If not, the process ends.

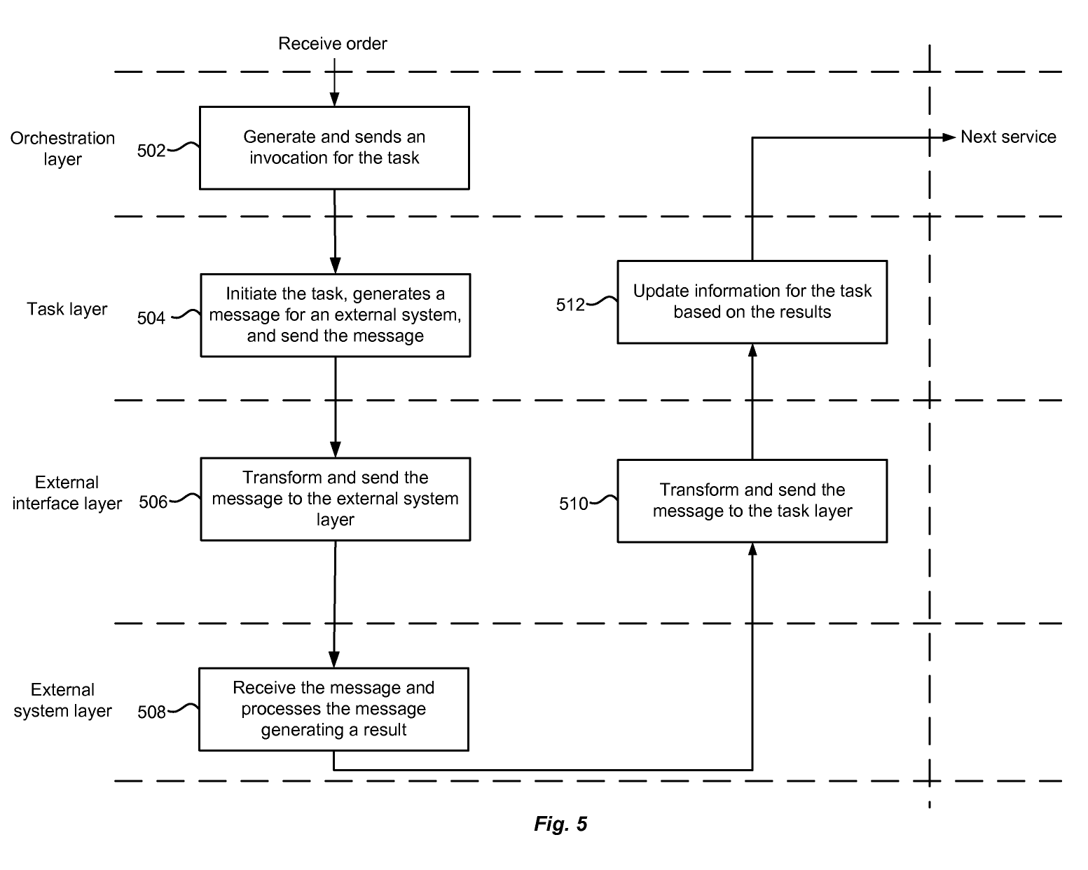

The orchestration of services is provided using information from table 200. However, in addition to orchestration, services need to communicate with external systems. FIG. 5 depicts a process for orchestration data flow among different layers according to one embodiment. An orchestration layer, task layer, external interface layer, and external system layer is provided.

Step 502 generates and sends an invocation for the task. An order may be received from an order capture system. This may cause a task to be invoked. The invocation request is generated using data found in the runtime table. The request is sent to the task layer.

Step 504 initiates the task, generates a message for an external system, and sends the message. The message generated indicates which task should be performed by the external system. The task to be performed is an aspect of order processing that has been modeled. For example, the task may be invoicing for an order. Parameters for performing the task are also included. The message is sent to an external interface.

Step 506 transforms and sends the message to the external system layer. The messages generated by the task layer may be in a generic format. Different external systems, however, may communicate using other formats. The external interface layer determines the format used by an external system and transforms the message. For example, metadata defined by a user may be used to determine the format to be used. In one example, mappings to what external systems call a product that was ordered are used to translate the message.

Step 508 receives the message returned by the external system and processes the message generating a result. The external systems may be systems that perform the task related to processing an order, such as a scheduling system, shipping system, etc. When the task is performed, the result of the task is determined. The result may be a date when a shipment is scheduled, a date when a good is shipped, etc. The result is then sent back to the external interface layer.

Step 510 transforms and sends the message to the task layer. Step 512 updates information for the task based on the results. For example, the results may be stored in a table or database. The process then continues to the next service that can be invoked.

Further description of a distributed order orchestration system is described in U.S. patent application Ser. No. ______, entitled “DISTRIBUTED ORDER ORCHESTRATION” (ORACP0023), filed concurrently and incorporated by reference for all purposes. Also, further details on orchestration are described U.S. patent application Ser. No. ______, entitled “REUSABLE BUSINESS SUB-PROCESSES AND RUN-TIME ASSEMBLY” (ORACP0005) and U.S. patent application Ser. No. ______, entitled “VERSIONING AND EFFECTIVITY DATES FOR ORCHESTRATION BUSINESS PROCESS DESIGN” (ORACP0006), all of which are filed concurrently with this application and all of which are incorporated by reference for all purposes.

By using encapsulated services that are defined using interface 108, changes can be made to an executable process 110 and implemented at runtime. For example, alterations to the metadata during the running of the process can influence the sequence of steps taken as well as the input arguments of the individual steps.

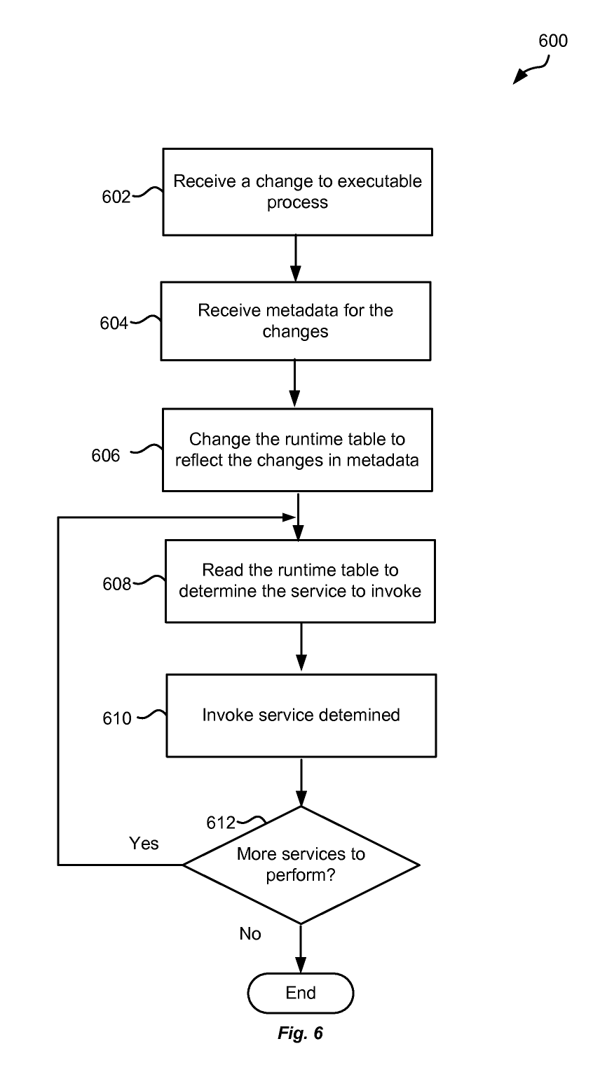

FIG. 6 depicts a simplified flowchart 600 of a method for changing a business process according to one embodiment. Step 602 receives a change to the business process. For example, interface 108 is used to change the business process to include different steps. In one example, steps may be replaced, steps may be deleted, or steps may be added.

Step 604 receives metadata for the changes. For example, runtime engine 112 may receive the changed metadata. Step 606 then changes the runtime table to reflect the changes in metadata. For example, executable process 110 may be changed to include different services to invoke.

When a service is to be invoked, step 608 reads the runtime table to determine the service to invoke. For example, step reader 404 may be reading the table during the processing of executable process 110. If the runtime table has been changed, step reader 404 determines the next step that needs to be performed based on the changes.

Step 610 then invokes the service determined. Because services can be called based on different input arguments, additional programming to re-deploy the new service is not needed when services in the business process are changed. Rather, the table may just be changed and different service can be automatically invoked.

Step 612 then determines if more services need to be performed. If so, the process reiterates to step 606 where the table is read again to determine the next step to perform. If not, the process ends.

Accordingly, data-driven orchestration provides abstraction and flexibility. The abstraction refers to the web-based administration of process metadata that defines the process steps in an executable process. Process code is re-used across different business processes. Flexibility refers to the ability to modify the processes without re-deployment of code. The use of changes to runtime metadata facilitates changes to executable process 110. Abstraction brings the process model closer to the business user and reduces administrative costs. Flexibility allows a business user to respond to change, such as the modification of process specifications when business processes or rules change.

Although the description has been described with respect to particular embodiments thereof, these particular embodiments are merely illustrative, and not restrictive. Although BPEL is described, it will be understood that other languages may be used.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for orchestrating an order fulfillment business process, the method comprising:
providing a plurality of services in the order fulfillment business process;
receiving, from an interface, a definition of a business process including one or more services from the plurality of services, the one or more services defined in steps to be performed in the order fulfillment business process;
during run-time, determining metadata for the definition received from the interface;
determining an orchestration sequence for an executable process of invoking the one or more services based on the metadata; and
dynamically invoking the one or more services in the executable process based on the determined orchestration sequence to process an order, wherein the invoking of a service facilitates performance of a service associated with the service.

2. The method of claim 1, further comprising:
receiving, from the interface, a change to the definition of the business process, the change identifying a second set of one or more services;
during run-time, reading metadata for the changed definition received from the interface;
determining a second orchestration sequence for a second executable process of the second set of one or more services based on the metadata; and
dynamically invoking the second set of one or more services in a second series of steps based on the determined orchestration sequence.

3. The method of claim 2, wherein the second set of one or more services includes a different service than that found in the one or more services, wherein redeployment of the second executable process is not needed.

4. The method of claim 1, wherein the plurality of services are services that are pre-defined based on services needed in the order fulfillment business process and include code that is re-used in different business processes.

5. The method of claim 1, wherein the plurality of services comprise non-configurable units that are generic and configurable units that are configured for a customer.

6. The method of claim 1, wherein determining the orchestration sequence for the executable process comprises using the metadata to determine an order of invoking the one or more services.

7. The method of claim 1, wherein determining the orchestration sequence comprises determining input arguments for the one or more services, the input arguments formatted in a signature that defines a common data format for inputting information into code for a service.

8. The method of claim 7, wherein different data for input arguments is input into the service module when the service module is used in different executable processes.

9. The method of claim 1, wherein the interface comprises a user interface that allows a user to specify the definition by selecting the one or more services from a menu listing the plurality of services.

10. The method of claim 1, further comprising:
generating a message for an external system to perform a service associated with a service in the one or more services;
sending the message to an external interface, the external interface configured to format the message for the external system; and
sending the formatted message to the external system.

11. The method of claim 10, further comprising receiving a result from the external system, the result including information for the service performed by the external system.

12. The method of claim 1, further comprising:
receiving an order from an order capture system; and
invoking a service in the executable process based on receiving the order.

13. A computer-readable medium comprising encoded logic for execution by the one or more processors to orchestrate an order fulfillment business process, the logic when executed operable to:
provide a plurality of services in the order fulfillment business process;
receive, from an interface, a definition of a business process including one or more services from the plurality of services, the one or more services defined in steps to be performed in the order fulfillment business process;
during run-time, determine metadata for the definition received from the interface;
determine an orchestration sequence for an executable process of invoking the one or more services based on the metadata; and
dynamically invoke the one or more services in the executable process based on the determined orchestration sequence to process an order, wherein the invoking of a service facilitates performance of a service associated with the service.

14. The computer-readable medium of claim 13, wherein the logic is operable to:
receive, from the interface, a change to the definition of the business process, the change identifying a second set of one or more services;
during run-time, read metadata for the changed definition received from the interface;
determine a second orchestration sequence for a second executable process of the second set of one or more services based on the metadata; and
dynamically invoke the second set of one or more services in a second series of steps based on the determined orchestration sequence.

15. The computer-readable medium of claim 14, wherein the second set of one or more services includes a different service than that found in the one or more services, wherein redeployment of the second executable process is not needed.

16. The computer-readable medium of claim 13, wherein the plurality of services are services that are pre-defined based on services needed in the order fulfillment business process and include code that is re-used in different business processes.

17. The computer-readable medium of claim 13, wherein logic operable to determine the orchestration sequence for the executable process comprises using the metadata to determine an order of invoking the one or more services.

18. The method of claim 13, wherein the interface comprises a user interface that allows a user to specify the definition by selecting the one or more services from a menu listing the plurality of services.

19. The method of claim 12, wherein the logic is operable to:
generate a message for an external system to perform a service associated with a service in the one or more services;
send the message to an external interface, the external interface configured to format the message for the external system; and
send the formatted message to the external system.

20. An apparatus configured to orchestrate an order fulfillment business process, apparatus comprising:
one or more processors; and
logic encoded in one or more tangible media for execution by the one or more processors and when executed operable to:
provide a plurality of services in the order fulfillment business process;
receive, from an interface, a definition of a business process including one or more services from the plurality of services, the one or more services defined in steps to be performed in the order fulfillment business process;
during run-time, determine metadata for the definition received from the interface;
determine an orchestration sequence for an executable process of invoking the one or more services based on the metadata; and
dynamically invoke the one or more services in the executable process based on the determined orchestration sequence to process an order, wherein the invoking of a service facilitates performance of a service associated with the service.
